(19) United States
(12) Patent Application Publication
(10) Pub. No.: US 2010/0299591 A1
(43) Pub. Date: Nov. 25, 2010

(54) MARKUP LANGUAGE DOCUMENT CONVERSION SYSTEM, DEVICE, METHOD, AND PROGRAM

(75) Inventors: Noriyuki Suehiro, Tokyo (JP); Takahiro Nakayama, Tokyo (JP); Kenji Nonoyama, Kanagawa (JP)

Correspondence Address: MORRISON & FOERSTER LLP, 425 MARKET STREET, SAN FRANCISCO, CA, 94105-2482, US

(73) Assignee: ACCESS CO., LTD., Chiyoda-ku (JP)

(21) Appl. No.: 12/864,229

(22) PCT Filed: Jan. 22, 2009
(86) PCT No.: PCT/JP2009/050948

§ 371 Date: Jul. 22, 2010

(30) Foreign Application Priority Data
Jan. 25, 2008 (JP) 2008-015310

(51) Int. Cl. G06F 17/00

(52) U.S. Cl. 715/239

(57) ABSTRACT

In a markup language document conversion system, the conversion server 150 acquires a PC markup language (ML) document from a PC web server 130 and subjects the document to rendering so as to check arrangement coordinates of respective display elements to be drawn on a display screen of a predetermined size. According to the check result, the PC ML document is converted to a mobile ML document 30 in which the display elements are rearranged in accordance with a specification of a mobile terminal. An edit terminal 170 accepts an edit operation for the ML document 30 and uploads edit procedure information being an edit result, to the conversion server 150. Thereafter, in response to a request of the PC ML document from the mobile terminal, the conversion server 150 allows the edit procedure application unit 190 to apply the edit procedure information to the ML document 30 and generates a mobile ML document 32.

### TECHNICAL FIELD

The present invention relates to a markup language document conversion system, a markup language document conversion device, a markup language document conversion method, and a markup language document conversion program, which convert a first markup language document such as a markup language document for personal computers (referred to as a PC markup language document, hereinafter), into a second markup language document such as a non-PC markup language (referred to as a non-PC or mobile markup language document, hereinafter) where an arrangement of display elements is changed in accordance with a specification of a mobile terminal, for instance.

### BACKGROUND ART

Recently, even though a web page at a web site on the Internet is designed specifically for PCs, browsing of such web page is becoming available also on a terminal used for mobile communication, which is a non-PC terminal such as a mobile phone terminal or a PDA equipped with a communication facility. In the present specification, a terminal device for mobile communication is referred to as a “mobile terminal”.

The size of the display screen of the mobile terminal is not uniform, but typically, it has a smaller resolution (number of pixels in rows and columns), relative to that of the display screen of the display device specific to a PC. Therefore, if a PC web page is tried to be displayed on the display screen on the mobile terminal, without any change, the web page being displayed largely extends off screen not only in the vertical direction but also in the horizontal direction. In this case, it becomes necessary to frequently scroll both in the vertical and horizontal directions.

Alternatively, it is conceivable to scale down the display of the web page so as to figure out the overall page, but this may cause a poor visibility in details, and it is likely that the characters become unreadable.

In order to attend to the problem as described above, patent document 1 discloses a technique that a large-sized web page is analyzed to be divided into smaller-sized sub pages, so that they are browsed on a mobile terminal.

Patent document 2 discloses a technique that a web page used for PCs is analyzed and converted into information suitable for being displayed on a wireless terminal.

Non-patent document 1 discloses a tool for manually editing a PC web page to convert the page into a mobile web page.

Patent document 1
U.S. Pat. No. 7,203,901

Patent document 2
U.S. Pat. No. 7,047,033

Non-patent document 1
MICS Network Inc., “MICS Network of CMS/New platform for establishing and managing a WEB site”, Search date: Oct. 31, 2007, the Internet <URL: http://www.micsnet.co.jp/mobile_future>

### DISCLOSURE OF THE INVENTION

### Problem to be Solved by the Invention

In the meantime, it is common to utilize a CSS (Cascading Style Sheet) for an HTML document which is recently used in a web site. The CSS is a function to collectively manage a decoration part (modification information) of the HTML document, and this function uses a CSS file to define the decoration part for a character and a background.

If it is required to execute a particular process within the web page, a type of program such as JavaScript (registered trademark) may be incorporated in the HTML document.

There has been a case that the HTML document to which the CSS is applied or the HTML document including the JavaScript or the like as described above, sometimes fails to be appropriately converted into a mobile markup language (ML), just by analyzing the HTML document.

By way of example, positions of respective display elements on the PC screen, which are estimated from a structure of the HTML document constituting the PC web page, may not necessarily agree with the actual positions after the CSS is applied or the JavaScript is executed. In such a case, if the conversion into the mobile ML document is performed based on only a result of analysis of the HTML document, there may be a possibility that a position for placing a particular display element is changed extremely (e.g., a display element to be positioned on the head in the PC actual display page comes to the last in the mobile actual display page), a particular display element fails to be displayed, and the like.

In order to attend to such problems as described above, the applicant of the present application proposed a technique, in Japanese patent application No. 2007-339878, which enables an automatic conversion from a first markup language document associated with a PC web page or the like, into a second markup language document associated with a mobile web page or the like, in a comparatively close manner.

However, in practice, there may be a request from a contents provider that a configuration of the web page on the display screen of a small mobile terminal is intentionally made different from the web page configuration for PCs. In addition, there may be a request to add an advertisement area for the mobile use.

In such cases as described above, according to the conventional technique, a PC web page is supposed to be edited from the beginning in order to create a mobile web page, and there is a problem that enormous amount of time is necessary if the data volume is large. In addition, the mobile web page edited as such has to be managed separately, by a mobile web site which is provided separate from the PC web site.

The present invention has been made in the background as described above, and an object of the present invention is to provide a markup language document conversion system, a markup language document conversion device, a markup language document conversion method, and a markup language document conversion program, which allow the conversion in a comparatively close manner, from the first markup language document associated with a PC web page or the like, into a second markup language document associated with the mobile web page, and facilitate editing and managing of the converted document.

### Means to Solve the Problem

The markup language document conversion system according to the present invention is provided with a markup language document conversion device for converting a first markup language document written in a first markup language, into a second markup language document written in a second markup language, and a markup language document edit device for editing the second markup language document being converted. In this system, the markup language document conversion device includes a means for acquiring the first markup language document written in the first markup language, and at least one of a data item and a program which accompanies the first markup language document, a means for subjecting the first markup language document and at least one of the data item and the program to rendering, and checking arrangement coordinates of respective display elements to be drawn on a display screen in a predetermined size, a means for performing conversion into the second markup language document written in the second markup language where the respective display elements are rearranged according to the display elements and the arrangement coordinates thereof being checked, a means for receiving edit operation procedure information for the second markup language document from the edit device and storing the information, and a means for performing conversion from the first markup language document into the second markup language document in response to an external request, editing the second markup language document according to the edit operation procedure information, and then sending the edited document to a source of the request. In addition, the markup language document edit device includes an operating means for accepting a user operation, an editing means for editing on a display screen according to the user operation, the second markup language document that has been converted by the markup language document conversion device, and a means for sending operation details of the editing to the markup language document conversion device, as the operation procedure information.

In the present invention, the second markup language document obtained from the conversion by the markup language document conversion device is used as a basis to accept editing by the markup language document edit device, and a result of the editing is stored as edit result information. When necessary, the edit result information can be automatically applied to a conversion result of the markup language document conversion device.

A web server may also be provided in which the first markup language document is stored, and in this case, the markup language document conversion device is allowed to acquire the first markup language document from the web server where the first markup language document is stored.

The first markup language may be a PC markup language, whereas the second markup language may be a non-PC markup language, for instance, and it is possible to perform the conversion according to a specification of an individual non-PC terminal.

The present invention could be directed to the markup language document conversion device or the markup language document edit device in this system.

The present invention could also be directed to a markup language document conversion method or a markup language document editing method.

Further alternatively, it is conceivable that the present invention is directed to a markup language document conversion program or a markup language document edit program.

### EFFECT OF THE INVENTION

According to the present invention, it is possible to automatically convert a PC web page into a mobile web page in comparatively close manner, allowing the PC contents to be browsed on a mobile terminal or the like. In addition, it becomes unnecessary for a contents provider (typically, a business organization) to separately prepare a mobile web page in association with each PC web page. As a result, the contents provider can be released from cumbersome processing loads, such as creating both the PC contents and the mobile contents, and further conducting a similar maintenance (synchronization) on both contents. Furthermore, the procedure for editing the mobile web page after conversion is stored as the edit procedure information, thereby enabling the same details of editing to be automatically executed as needed.

### BRIEF DESCRIPTION OF DRAWINGS

FIG. 1 illustrates a schematic configuration of an overall markup language document conversion system in an embodiment of the present invention;

FIG. 2 is a diagram for explaining a basic concept of a conversion server according to the present invention;

FIG. 3 illustrates an internal configuration of the browser engine which is shown in FIG. 2;

FIG. 4 illustrates a functional configuration example of the conversion server in an embodiment of the present invention;

FIG. 5 illustrates a general screen of a home page;

FIG. 6 illustrates a schematic configuration of an HTML document which constitutes the web page as shown in FIG. 5;

FIG. 7 illustrates a screen which represents the results of parsing and rendering of the HTML document constituting the web page which is shown in FIG. 5, the parsing and the rendering being performed by the browser engine;

FIG. 8 is a schematic illustration in the form of tree, showing display elements (i.e., parts) such as block elements and the like within the screen;

FIG. 9 is a schematic illustration showing a state that the PC web page shown in FIG. 7 is converted into a mobile web page and displayed on a mobile screen;

FIG. 10 is an illustration showing a state that blocks 211 to 237 corresponding to multiple elements shown in FIG. 9 are folded in one block, represented by the block 211 which is one of the elements;

FIG. 11 is a flowchart showing a processing procedure of the conversion server which is shown in FIG. 1;

FIG. 12 is a flowchart showing a processing example of the “folding” process in the step S16 which is shown in FIG. 11;

FIG. 13 is a diagram for explaining an operation for editing the conversion result from the conversion server shown in FIG. 1, and an operation for modifying the mobile ML document based on a result of the edit operation;

FIG. 14 illustrates a configuration example of an edit screen in the display unit of an edit terminal which is used by an editor;

FIG. 15 illustrates blocks respectively associated with the display elements within a conversion preview area of the edit screen which is shown in FIG. 14;

FIG. 16 illustrates an example of “addition of text frame (a type of block)” as one example of editing in an embodiment of the present invention;

FIG. 17 illustrates a specific configuration example of the text input screen which is shown in FIG. 16(c);

FIG. 18 illustrates an example for adding an image frame, as another example of editing in an embodiment of the present invention;

FIG. 19 illustrates the “shift of block” which shifts an existing block, as a further alternative example of editing in an embodiment of the present invention;

FIG. 20 illustrates the “addition of horizontal line”, as another example of the editing in one embodiment of the present invention;

FIG. 21 illustrates the “deletion of block” which deletes an existing block as a further alternative example of editing in an embodiment of the present invention;

FIG. 22 illustrates the “editing of block” for modifying the details of a block, as another example of the editing in one embodiment of the present invention;

FIG. 23 illustrates an example of the “replacement of image/text” for replacing an image by a text, as a further alternative example of editing in an embodiment of the present invention;

FIG. 24 is a flowchart showing a schematic procedure of a basic edit process on the edit terminal in an embodiment of the present invention; and

FIG. 25 illustrates a configuration example of the edit procedure information storage unit which is shown in FIG. 13.

### DENOTATION OF REFERENCE NUMERALS

10 . . . MARKUP LANGUAGE (ML) DOCUMENT, 20 . . . BROWSER ENGINE, 26 . . . DRAWING DOCUMENT TREE, 32 . . . MOBILE ML DOCUMENT, 110 . . . MOBILE TERMINAL, 120 . . . web SERVER, 130 . . . PC web SERVER, 140 . . . COMMUNICATION NETWORK, 150 . . . CONVERSION SERVER, 152 . . . SESSION MANAGER, 156 . . . CONVERSION RESULT CACHE MANAGER, 157 . . . CONTENTS ACQUISITION INFORMATION CACHE MANAGER, 158 . . . CONTENTS DATA CACHE MANAGER, 160 . . . TRANSCODER ENGINE, 161 . . . CONVERSION PROCESSOR, 162 . . . TRANSCODER FRONT END, 170 . . . EDIT TERMINAL, 171 . . . EDIT PROCESSOR, 172 . . . DISPLAY UNIT, 173 . . . INPUT OPERATING UNIT, 174 . . . COMMUNICATION UNIT, 175 . . . EDIT PROCEDURE INFORMATION STORAGE UNIT, 180 . . . EDIT PROCEDURE INFORMATION STORAGE UNIT, 190 . . . EDIT PROCEDURE APPLICATION PROCESSOR, 200 . . . DESCRIPTION, 210a. MINUS MARK, 210b . . . PLUS MARK, 211 . . . BLOCK, 241 . . . IMAGE, 470 . . . PREVIEW AREA, 400 . . . EDIT DISPLAY, 410 . . . FILE MENU, 420 . . . MAIN TOOL BAR, 430 . . . ADDRESS BAR, 440 . . . BROWSER TOOL BAR, 450 . . . SITE TREE DISPLAY AREA, 460 . . . PREVIEW AREA, 470 . . . CONVERSION PREVIEW AREA, 473 . . . TEXT FRAME, 474 . . . IMAGE FRAME, 475 . . . HORIZONTAL LINE, 476 . . . POP-UP MENU, 480 . . . EDIT TOOL BAR, 490 . . . TEXT INPUT SCREEN, 491 . . . OPERATION COMMAND BUTTON GROUP, 492 . . . CONTENTS EDIT AREA, 493 . . . SOURCE DISPLAY AREA, 495 . . . TEXT EDIT DISPLAY, 510 . . . IMAGE SELECTION SCREEN, 512 . . . IMAGE FILE, 520 . . . SET-UP SCREEN

### BEST MODE FOR CARRYING OUT THE INVENTION

Hereinafter, preferred embodiments of the present invention will be explained in detail, with reference to the accompanying drawings.

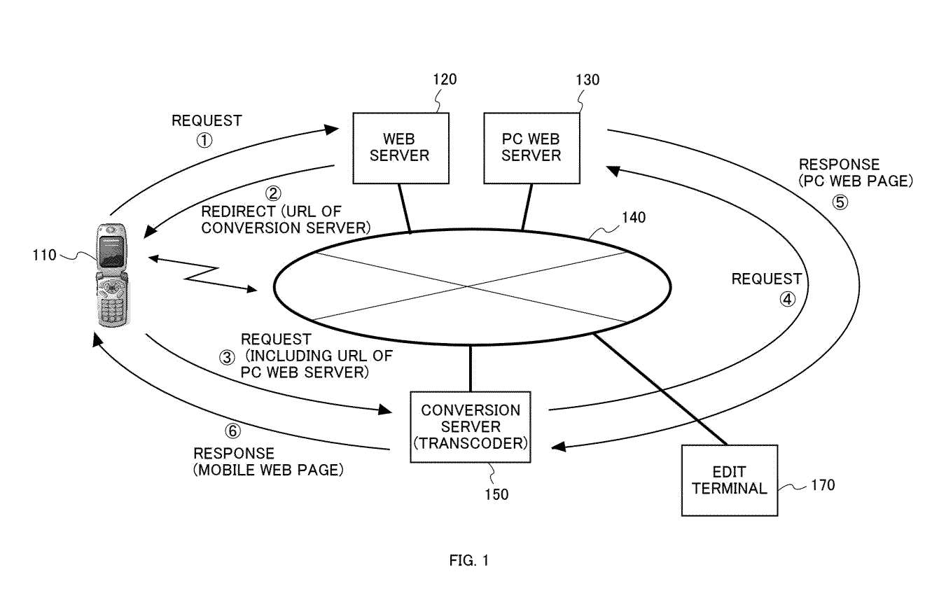

FIG. 1 illustrates a schematic configuration of the overall markup language document conversion system according to the present embodiment.

This system comprises a mobile terminal 110 being a mobile communication terminal device such as a portable phone terminal and a PDA with a communication facility, a web server 120 (for any usage, specific to PC or mobile use) to provide web contents, a PC web server 130 for providing PC web contents, a conversion server 150 which corresponds to the markup language document conversion device according to the present invention, an edit terminal (i.e., edit device) 170 such as a PC, for manually editing a conversion result from the conversion server 150, and a communication network 140 such as the Internet, to which each of the servers and the edit terminal 170 are connected.

The conversion server 150 is a server to convert in real time a PC markup language (ML) document constituting a PC web page (i.e., a first markup language document) into a mobile ML document constituting a mobile web page (i.e., a second markup language document), and this server is also referred to as a transcoder. The communication network 140 may include a mobile packet communication network and a gateway (not illustrated) for establishing communication between this communication network and the Internet. The web server 120 may be a server which is connected to the mobile packet communication network, instead of the Internet. The edit terminal 170 may have a configuration which is directly connected to the conversion server 150, without going through the communication network 140.

According to a user's operation on the mobile terminal 110, the web browser of the mobile terminal 110 requests a specific web page to the web server 120 (step 1). The web browser of the mobile terminal transmits this request including information referred to as “user agent (UA)”.

The web server 120 is able to determine a model ID of the mobile terminal based on the user agent information being received, and accordingly, it is possible to check the specification information of the model. This specification information may include, for instance, a display screen size, an available memory size, the web data amount which is processible at once, a support format, and the like. As a response to the request described above, redirecting information (including the URL of the conversion server 150) is sent back from the web server 120 to the mobile terminal 110 (step 2). The redirecting information is a response to change a destination of access to a specific site (here, the conversion server 150), from the web server itself, when the web server 120 figures out based on the user agent information that the terminal requesting the web page (a request source) is a mobile terminal.

The mobile terminal 110 receives this redirecting information, accesses the conversion 150, and requests a target PC web page (step 3). In other words, this request includes the URL of the PC web server 130.

Alternatively, instead of using the redirecting information, the mobile terminal 110 may directly access the conversion server 150 according to the URL of the conversion server 150 being incorporated in the mobile web page, or according to a manual input of the URL.

Upon receipt of the request as described above, the conversion server 150 accesses the PC web server 130 being designated, and requests a PC web page written in the PC markup language document that is to be converted in such a manner as suitable for the mobile terminal (step 4). Then, the conversion server 150 acquires an ML document of the PC web page as the response from the PC web server 130 (step 5). The conversion server 150 serves to rendering, the PC ML document being acquired, as well as a data item and a program which are acquired as needed together with the acquired PC ML document, automatically creates a mobile ML document based on the result of the rendering, and then sends it back to the mobile terminal 110 as a response (step 6). The mobile terminal 110 receives the mobile ML document being sent back, processes the document by the web browser, further acquires the accompanying necessary data item and program, subjects them to rendering, and displays the result on the mobile display screen. The “accompanying data item and program” include, for example, modification information such as CSS which is referred to from the ML document, an image (including advertising image), a script such as JavaScript, plug-in data such as Flash, and the like. Generally, “rendering” means creation of an image from the information regarding an object and graphics given in the form of numerical data, according to processing of the data. In the present specification, the rendering indicates that the web browser reads a markup language document such as an HTML, interprets various tags, decides where and how to display various display elements on the display screen, and creates drawing data for display. The rendering may include a CSS analysis, execution of JavaScript, or the like.

Preferably, the conversion server 150 inserts a page break based on the “web data amount processible at once” of the terminal from which the request is received, by sectioning the data of the mobile ML document for each unit quantity corresponding to the web data amount processible at once. As a method for the page breaking, it is possible to employ any existing technique. By way of example, an anchor tag having a name such as “next page” which links to the details of the next page is provided at the last of each page within the mobile ML document. It is to be noted that the request from the mobile terminal to the conversion server 150 also has a user agent, and the conversion server 150 is allowed to identify the model ID of the mobile terminal according to the user agent information being received. Accordingly, it is possible to check the specification information of the model. For this purpose, the conversion server 150 holds association data between the model ID and the specification information, though not illustrated.

The edit terminal 170 receives a result of conversion from the conversion server 150, which is a converted version of a particular PC ML document (mobile ML document), and a user manually performs a desired editing (such as addition, deletion, modification of any display element). Preferably, the editor uses an edit software which is dedicated to implementing the processing of the present embodiment, to perform editing by an interactive operation on the display screen according to a graphical user interface (GUI). A result of the editing is uploaded to the conversion server 150 as edit procedure information. The edit procedure information is a description of the edit procedure representing the result of the editing which the edit processor 171 has performed on the mobile ML document in response to a directive operation of the editor. Afterward, upon receipt of a request from the mobile terminal 110 to convert the PC ML document, the conversion server 150 not only performs a regular automatic conversion, but also applies the edit procedure to the conversion result, based on the edit procedure information being accumulated, and returns the mobile ML document obtained as the editing result to the mobile terminal 110.

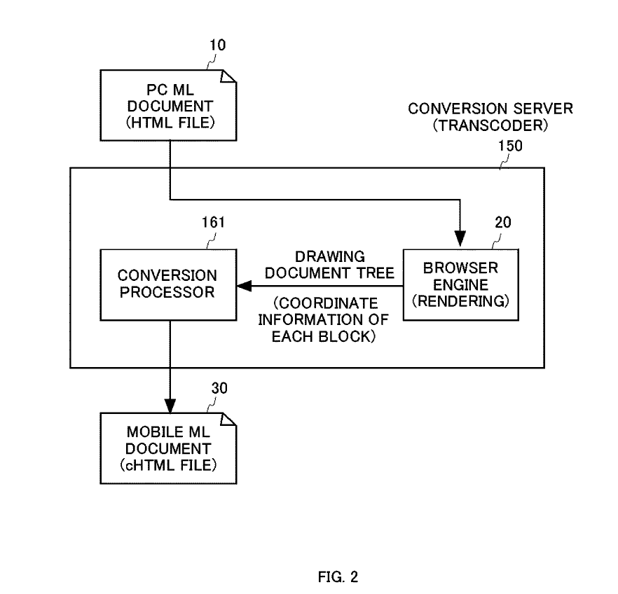

FIG. 2 is a diagram for explaining a basic concept of the conversion server 150 according to the present invention. The conversion server 150 includes a browser engine 20 having a function equivalent to a browser engine of a conventional web browser, and a conversion processor 161. The browser engine 20 reads a PC ML document 10 such an HTML file, and subjects the document to rendering. Then, the browser engine transmits to the conversion processor 161, each of the parts being the display elements arranged on an assumed PC display screen having a typical regulation size (e.g., 600 pixels high by 800 pixels wide), and a drawing document tree representing a parent-child relationship information, as well as arrangement coordinate information indicating areas to be occupied (blocks) of the parts. The conversion processor 161 generates, based on the parent-child relationship and the arrangement coordinate information of the parts, a mobile document (e.g., cHTML document) which is suitable for the display on the mobile terminal. The mobile ML document generated as described above is modified according to the edit procedure information, but details of the editing and the modification based on the edit procedure will be described below.

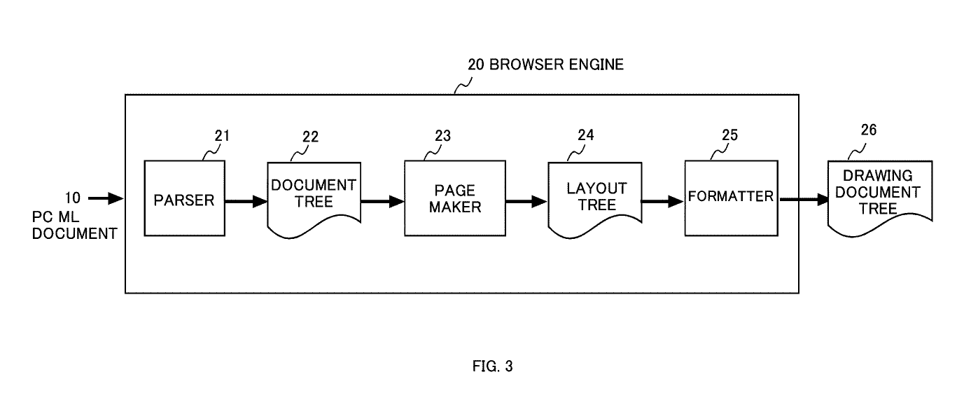

FIG. 3 illustrates an internal configuration of the browser engine 20 which is shown in FIG. 2. The browser engine 20 includes respective functions of a parser 21, a page maker 23, and a formatter 25. The parser 21 parses a logical structure of the markup language (ML) document 10 as a display target, and generates a document tree 22 relating to the structure. The page maker 23 generates, based on the document tree 22, a layout tree 24 including information of the expressive forms (block, inline, table, list, item, and the like) which are defined by respective tags. This layout tree 24 expresses in what order these block, inline, table, and the like are placed. However, the layout tree 24 does not include yet, information regarding the layout such as where in the screen and in what width and height these elements are displayed, and where character strings are wrapped around. On the basis of the layout tree 24, the formatter 25 performs the layout, by using the information regarding the actual display screen such as an already-known display screen width. In other words, the formatter arranges the layout tree 24 on the actual display screen, and decides a wrap-around position of characters, a location, width, and height of the elements on the screen. At this stage, a drawing document tree (also referred to as “rendering tree”) 26 is generated. In the present embodiment, the drawing document tree 26 includes diagonal coordinates of the block of each of the parts.

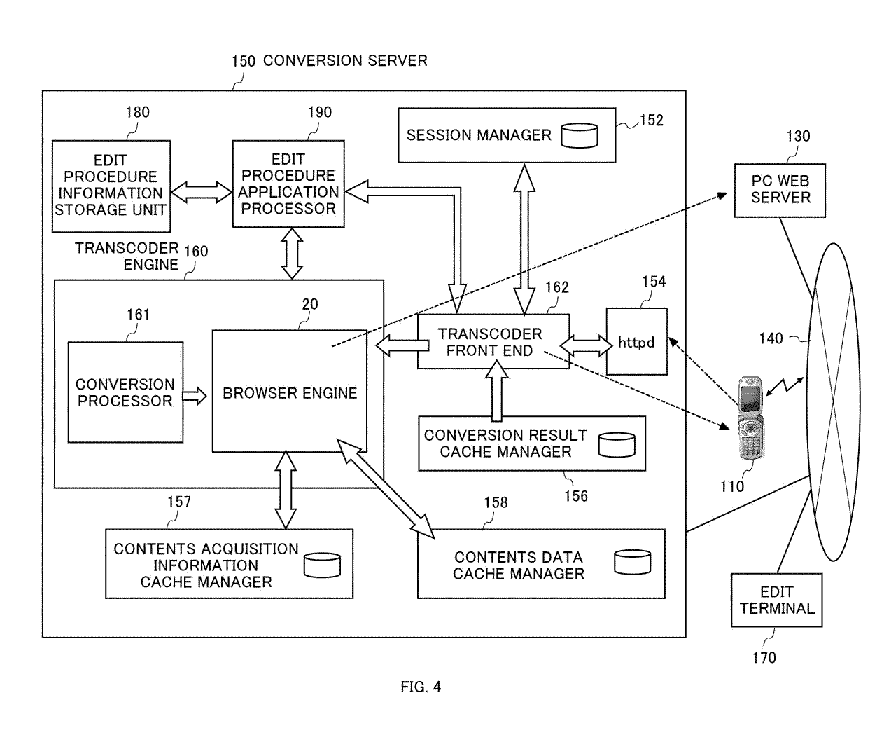

FIG. 4 illustrates a functional configuration example of the conversion server 150 in the present embodiment.

The transcoder engine 160 serves as a center of the conversion server 150, and includes the browser engine 20 and the conversion processor 161. The configuration and function of the browser engine 20 are as noted above. As described with reference to FIG. 2, the conversion processor 161 is a portion for performing the conversion process from the PC ML document to the mobile ML document, by using the processing result of the browser engine 20. The processing procedure will be specifically described below.

The present invention enables the conversion from the PC contents to the mobile contents in real time on occasion demands, and therefore, the contents provider does not have to have a bother of creating a web site specific to a mobile site, separately from the PC web site.

A contents data cache manager 158 is a device for temporarily storing data of a pre-conversion web page (ML document, JavaScript, CSS, Cookie, image, and the like).

A contents acquisition information cache manager 157 is a device for temporarily storing as cache meta information, an expiration date, an associated URL, and the like of each data.

The session manager 152 is a device for managing a session when accessing a web site. It often happens in a web world that a state of a user is embedded in the page, so that the user is allowed to use the site continuously. The place where it is embedded is in a URL query or in a Cookie. This kind of processing is referred to as a session.

The transcoder front end 162 is a server-side script processor which uses an HTML embedded server-side scripting language to implement a function such as the CGI (Common Gateway Interface). The CGI is a structure to allow a user program to run on the web server, and the user program is a server-side script. When a user clicks something on the terminal or transmits something in a form, the transcoder front end 162 executes a program according to such user's action, generates a new ML description, and transmits the description to the browser. As the scripting language, PHP (Hypertext Preprocessor) is used in the present embodiment, but it is not limited thereto.

The conversion result cache manager 156 is a device for temporarily storing the mobile ML document as a result of the conversion performed in the conversion processor 161.

It is to be noted that “httpd” (Hyper Text Transfer Protocol Daemon) 154 is a program of the web server, which is referred to as “http daemon”, and this program is provided to transmit contents stored within the server or start up a server-side script, in response to a request from the user.

The edit procedure information storage unit 180 is a part for storing the edit procedure information received from the edit terminal 170. Specifically, the edit procedure information storage unit 180 is made up of a storage means which is capable of storing data in non-volatile manner, such as a hard disk device, a flash memory, or a battery backup RAM. When the edit procedure information is stored as to a conversion target ML document, an edit procedure application processor 190 applies the edit procedure to the ML document.

It is to be noted that a hardware configuration of the conversion server 150 is implemented by the use of an existing hardware configuration, though not specifically illustrated, including a CPU, a main storage unit, an external storage unit, a communication unit, various input-output units, and the like.

Hereinafter, with reference to an example of specific web page, operations of the conversion server 150 according to the present embodiment will be explained.

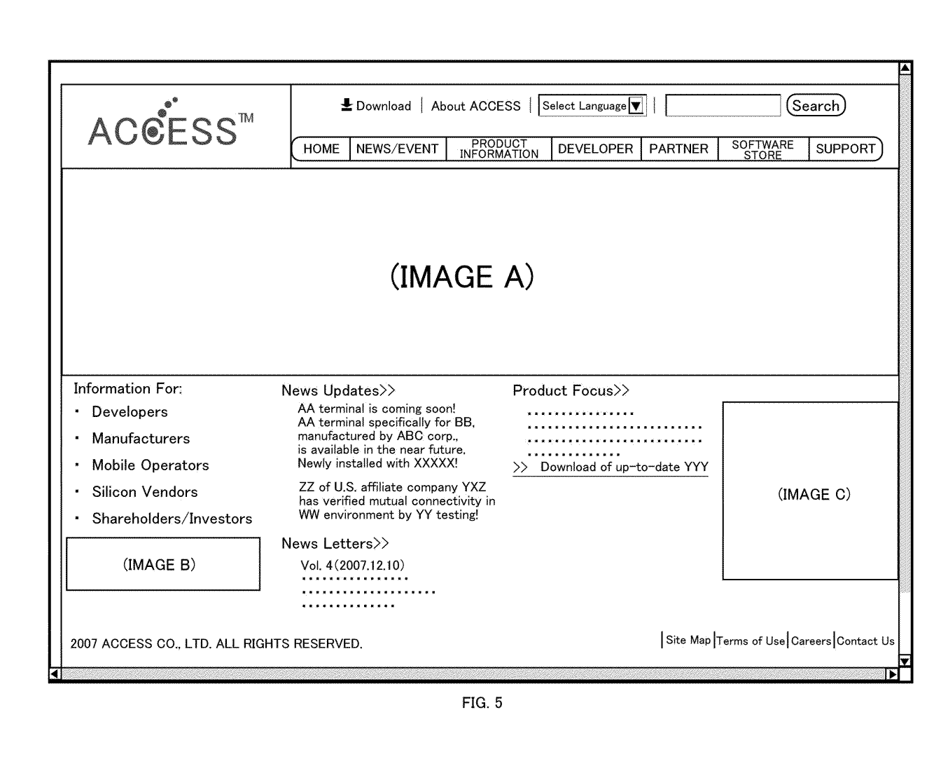

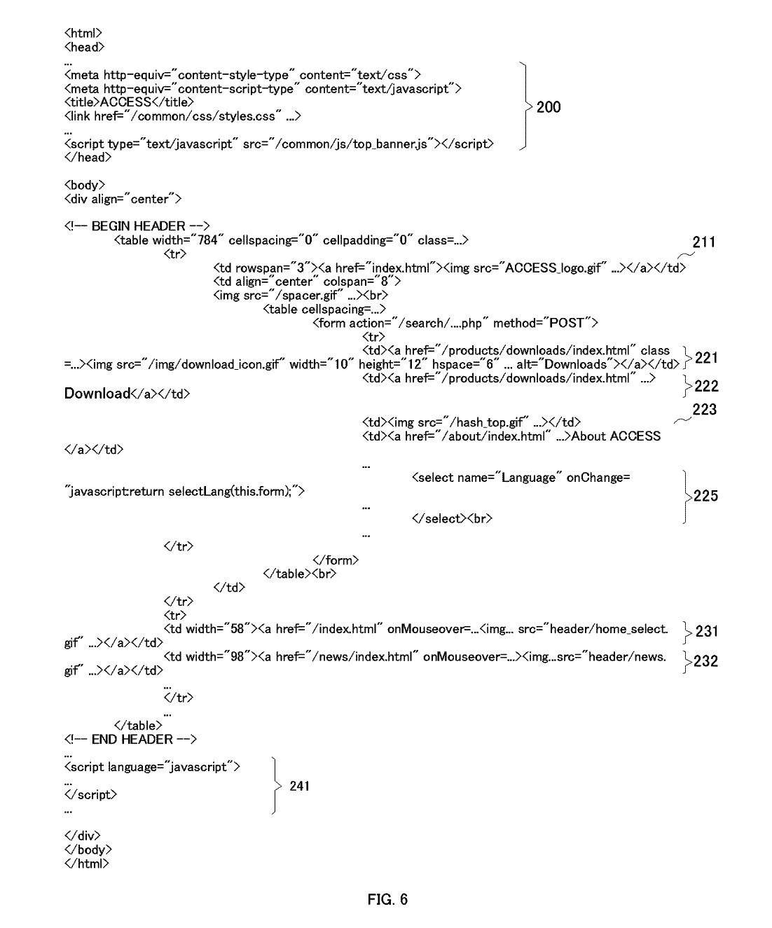

FIG. 5 illustrates a general screen of a home page. FIG. 6 illustrates a schematic configuration of the HTML document which constitutes this web page.

The HTML document is written in a text including various tags, and the display elements constituting the web page are primarily classified into “block element” and “inline element”.

The block element is an element serving as a framework of the document and it represents a heading, a paragraph, or the like, for instance. This type of element has an area fully in width within the given region, and a linefeed is automatically provided before and after this element. The area occupied by the block element on the browser screen is not only a portion where a character string and/or an image exist, but also a rectangular (block-shaped) area containing them. Specifically, the block element may include headlines (h1 to h6), (semantics) paragraph (p), chapter/semantics paragraph (div), separator (hr), quoting (blockquote), table (table), and the like. List (ul/ol/dl) and its items (li/dt/dd) are also included in the block element.

The inline element is an element which is treated as one part of a sentence (e.g., a link, highlighting of a character). Since this type of element is treated as a part of a line, the line feed is not entered before and after the element. Specifically, the inline element may include, link/anchor (a), highlighting in the unit of word/clause/sentence (em/strong), an output result of a program (samp), a source code of a program (code), explicit statement of an origin of quoting (cite), a forced page break (br), and the like. An image (img) is also included in the inline element.

There is a possibility that another block element and/or inline element may be included in the block element. Another inline element may be included in the inline element. However, any block element is not included in the inline element.

In many cases, the tag is made up of a start tag < > and an end tag </>. Another tag may be put in between the start tag and the end tag, in other words, a nest may be formed. As for the tags in the nesting relationship, the outside tag is referred to as “a parent”, and the inside tag is referred to as “a child”.

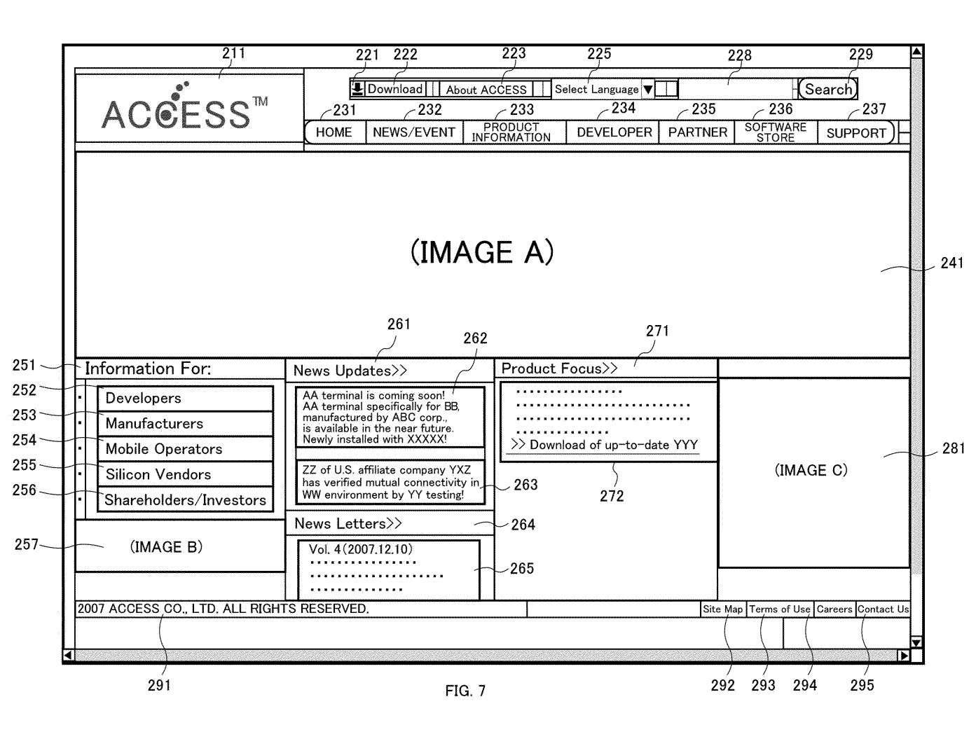

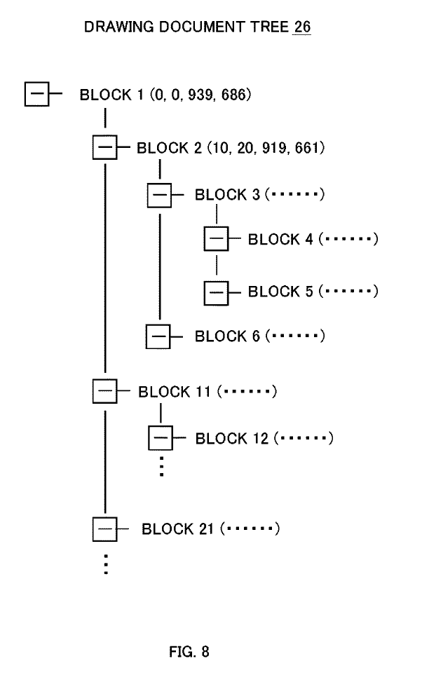

As described above, the browser engine 20 reads the HTML document, parses the document, and subjects the document to rendering. Consequently, as shown in FIG. 7, the display position (arrangement coordinate) and the size (diagonal coordinates of the rectangular occupied area) are obtained for each of the display elements (i.e., parts) such as the block element. FIG. 8 schematically illustrates the situation above in the form of tree. The “block” in this illustration corresponds the block of each of the display elements as shown in FIG. 7. Each block is provided with the diagonal coordinates defined in the form of (X1, Y1, X2, Y2). By way of example, (X1, Y1) represent the coordinates of the upper-left corner of the rectangular block, and (X2, Y2) represent the coordinates of the lower-right corner of the block.

The drawing document tree shown in FIG. 8 is based on a result after parsing the CSS. In the case where the JavaScript is included in the HTML document to define the display elements, the document tree reflects the result obtained by executing the JavaScript. By way of example, in the case where a process to display an image is performed according to the JavaScript in the description 200 shown in FIG. 6, the image being randomly selected from multiple images being prepared, the displaying of the “image A” in FIG. 7 corresponds to the state where the selected image is actually displayed on the web page. In some cases, the CSS may designate the coordinates to arrange the block, and in that case, the block position as a result of applying the CSS is considered. In addition, a comment line of the CSS is excluded from the display target without fail.

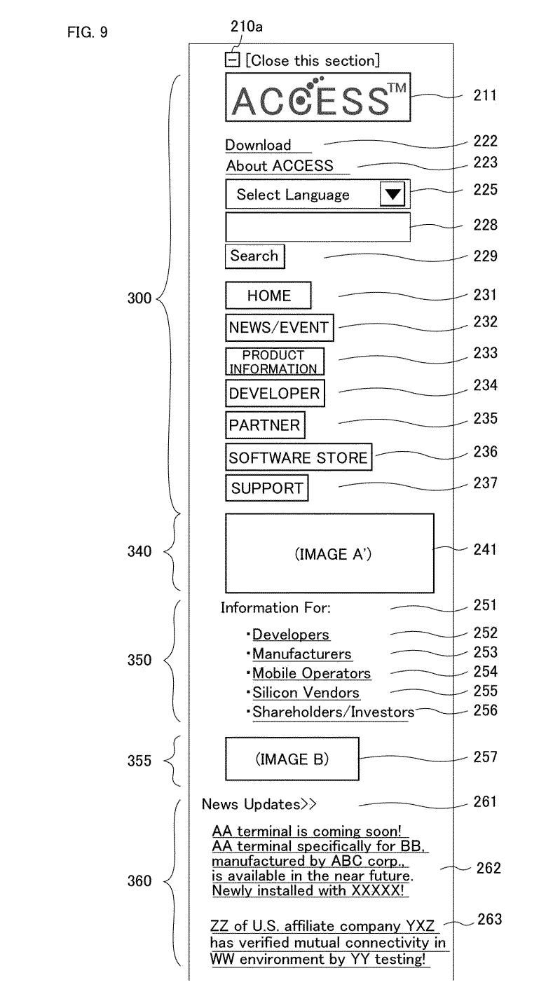

The conversion processor 161 rearranges the parts placement to be suitable for the mobile terminal, based on the parent-child relationship of the parts and the coordinate information. Upon this rearrangement, preferably, the web page is configured in such a manner that any scrolling in the horizontal direction is not required on the display screen of the mobile terminal. Therefore, in the case where listing of multiple parts in the lateral direction (horizontal direction) of the screen may cause some parts to extend off the display screen of the mobile terminal, the lateral arrangement of the multiple parts is changed to the vertical arrangement. By way of example, the arrangement of the block 211, the blocks 221 to 229, the blocks 231 to 237 on the upper position of FIG. 7 are changed to the vertical arrangement as shown in the position 300 of FIG. 9. FIG. 9 is a schematic illustration showing a state that the PC web page shown in FIG. 7 is converted into a mobile web page and displayed on a mobile screen. In practice, the overall details shown in FIG. 9 do not fit into the mobile screen, and a hidden part can be shown by shifting in the vertical direction on the mobile screen, according to page switching and/or scrolling operation. As for the lateral direction, it is assumed that the whole width of the page fits into the mobile screen.

When one image has a width larger than the display screen size, optimization is performed by reducing the overall image size so that the width fits into the mobile display screen size. The image 241 (image A) of FIG. 7 is arranged at the position 340 immediately below the position 300 of FIG. 9, as an image 241′ (image A′) which is optimized.

Since all of the blocks 251 to 256 of FIG. 7 arranged in the vertical direction originally fit into the mobile display screen size, they are arranged at the position 350 immediately below the position 340 of FIG. 9.

As for the block 257 of the image as shown in FIG. 7, the width thereof fits into the mobile display screen size, and therefore, it is arranged at the position 355 immediately below the position 350 of FIG. 9.

The blocks 261 to 265 of FIG. 7 are also arranged at the position 360 immediately below the position 355 of FIG. 9.

The blocks 271 to 272 of FIG. 7 are also arranged at the position (not illustrated) immediately below the position 360 of FIG. 9.

As for the block 281 in the image as shown in FIG. 7, the width thereof fits into the mobile display screen size, and therefore, it is arranged at the position immediately below the position 272 in FIG. 9. It is to be noted that the arrangement position of the image is determined by the coordinates of the block element of its parent. The size of the image is referred to when the image is reduced or enlarged.

The block 291 of FIG. 7 is arranged at the position immediately below the block 281. Since the width-to-length ratio of the block 291 is large, it is possible to perform “folding” which will be described below. However, since there is no change in information volume even after the folding, it is assumed that folding is not performed in the example here. In the case where the character string is longer than the width of the mobile display screen, it is displayed in such a manner as wrapped around according to a browser function.

As for the blocks 292 to 295 of FIG. 7, since these blocks as a whole fit into the mobile display screen size, they are arranged at the position immediately below the block 291. It is to be noted, however, the blocks 292 to 295 may be rearranged to be aligned in the vertical direction.

Arrangement of multiple parts sequentially from the top in the mobile display screen is conducted under predetermined rules which define in what order these parts on the PC screen are to be picked up. In the example described above, multiple parts on the PC screen are sequentially selected from left to right at the top, and upon reaching the right end, going below, and then sequentially selected from left to right.

It is to be noted that when multiple small parts can be contained in one large block which fits into the width of the mobile screen, these small parts are treated as one unit (blocks 252 to 256, etc., in FIG. 7).

The multiple parts having the same width size and aligned in the vertical direction are selected from the top to the bottom, and thereafter, shifting is made to the right (blocks 251, (252 to 256), 257, etc.)

Such rules as described above are provided just for illustrative purposes and they do not limit the scope of the present invention.

In the meantime, as is evident from FIG. 9, when the horizontally long description parts (blocks 231 to 237 in FIG. 7), so-called “navigation” on the PC web page, are aligned vertically on the mobile screen in the initial state, this may result in that those parts occupy most of the mobile screen, causing some inconvenience.

Given this situation, as shown in the uppermost part of FIG. 9, an indicator titled as “Close this section” is provided on the mobile screen, establishing a structure that when the user of the mobile terminal designates the minus mark 210a, a group of the multiple elements vertically aligned becomes collectively represented by one element. This structure is referred to as a “folding”. Even in the case where there is just one element which is a large size, it may be displayed being replaced by a smaller element. Such process may also be included in the folding.

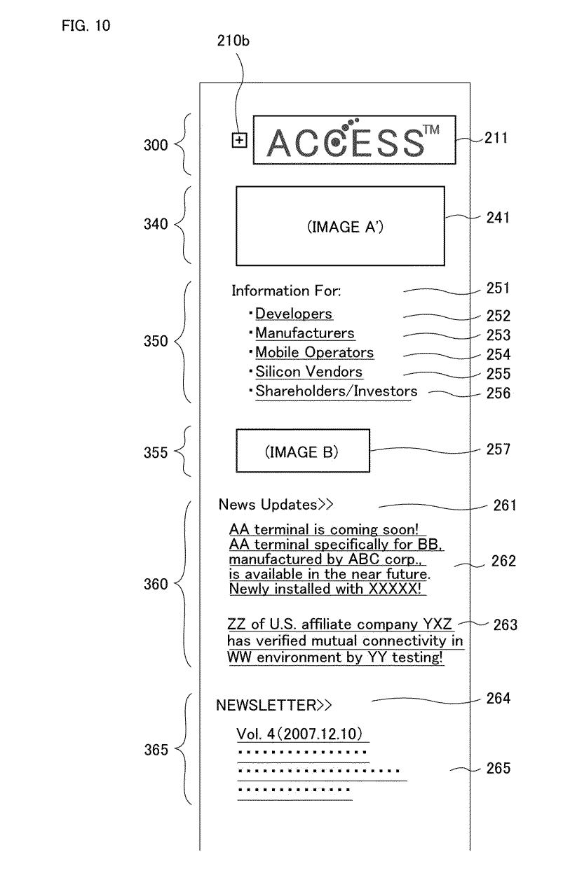

FIG. 10 is an illustration showing a state that blocks 211 to 237 corresponding to multiple elements are folded in one block, represented by the block 211 which is one of the elements. On this occasion, an indicator of plus mark 210b is provided on the side of the block 211 on the mobile screen, and when the user of the mobile terminal designates this mark, the display state of FIG. 9 is resumed (i.e., the multiple display elements having been folded are restored to the vertically aligned state).

The structure of the indicators, the minus mark 210a and plus mark 210b, is not supported by a general web browser function, and therefore, this function may be implemented by the aforementioned CGI.

FIG. 6 shows an example that the CGI is implemented by using the PHP which is an HTML embedded server-side scripting language. The PHP script operates on the web server, and every time a document on the web is requested, the PHP program included in this document is executed, and the result thereof is transmitted to the browser.

A description example of the PHP script for the folding is not specifically indicated in particular. However, execution of the PHP script corresponds to the processing to resume the state before folding (i.e., not folded) in response to a request from the mobile terminal in the state of folded, and also corresponds to the processing to resume the state being folded in response to a request from the mobile terminal in the state before folding.

It is to be noted that an explanation has been made assuming that the illustration of FIG. 9 is displayed initially as a default, but it is further possible to display the illustration of FIG. 10 prior to FIG. 9. Which is selected as a default depends on the selection by the user who makes a designation using a URL query in the request from the mobile terminal, for instance.

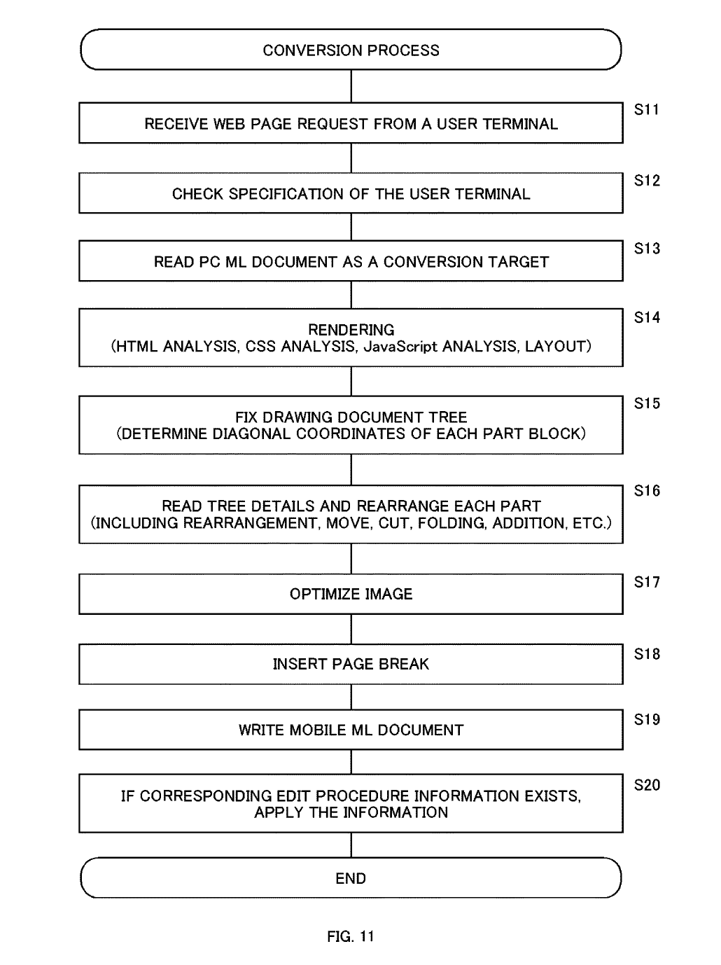

FIG. 11 is a flowchart showing a processing procedure of the conversion server 150. The CPU executes a markup language document conversion program, thereby implementing this process.

Firstly, a request of a web page from a mobile terminal is received (S11). On this occasion, the specification of the mobile terminal is checked according to the user agent information which is included in the request (S12).

Next, the browser engine 20 of the conversion server 150 requests the PC ML document as a conversion target to the web server being designated, and reads the document (S13). When the PC ML document is cached, the reading is performed from the cache unit.

Then, the PC ML document is subjected to rendering (S14). This rendering may include not only HTML analysis but also CSS analysis and execution of JavaScript, or the like. As a result, the drawing document tree is fixed (S15). In other words, the position and the size of each of the parts displayed on the PC display screen are determined according to the diagonal coordinates of each of the block.

The conversion processor 161 of the conversion server 150 reads the details of the drawing document tree, and rearranges each of the parts according to the predetermined rules as described above (S16). This rearrangement may include shifting, cutting, folding, adding, and the like, of the part. The “adding” process is to add any new element, and for instance, adding of advertisement is conceivable. If necessary, optimization may be further performed, such as reducing the image as described above (S17). In addition, a page break is inserted to be suitable for the terminal (S18). The conversion processor 161 refers to the specification of the mobile terminal in performing the processing from S16 to S18, so as to reflect the specification to the processing.

According to the procedure as described above, the mobile ML document is written in a predetermined storage area (S19).

Furthermore, in the case where edit procedure information associated with this mobile document exists in the edit procedure information storage unit 180, the edit procedure is applied to the mobile ML document to modify the document (S20). This mobile ML document being modified is stored in the conversion result cache manager 156, and sent back to the mobile terminal 110.

Once the mobile ML document is cached, when the mobile ML document is requested, it is read from the conversion result cache manager 156 and then used, without subjected to the conversion process and/or modification process again.

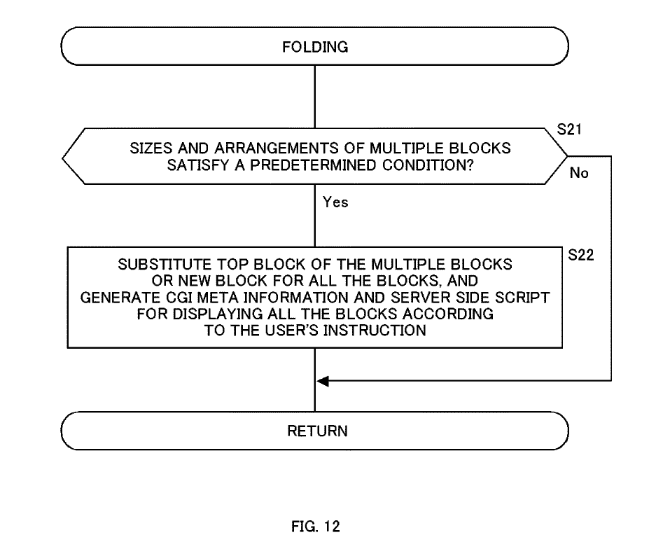

FIG. 12 is a flow chart showing a processing example of the “folding” process in the step S16 which is shown in FIG. 11.

At first, it is checked whether or not the sizes and arrangements of multiple blocks satisfy a predetermined condition (S21). For example, the predetermined condition indicates the following; blocks each having a height equal to or lower than a predetermined value, are aligned in the lateral direction, the number of the blocks being the predetermined number or more, and when the conversion to the mobile use is made, the blocks being a predetermined number or more are aligned vertically. The condition may also include a situation that even when the number of the block is only one, its area is equal to or larger than a predetermined value.

If the predetermined condition is not satisfied, the process of FIG. 12 is terminated. If the predetermined condition is satisfied, the top block of the multiple blocks, or a newly provided block (new block) substitutes for these blocks, and CGI meta information is generated to display all the blocks according to an instruction from a user, and the meta information is added to the mobile ML document (S22). On this occasion, the descriptions of the blocks being contained are deleted from the mobile ML document. In addition, a corresponding server-side script is generated, and it is held on the conversion server side. In this process, the state being closed is assumed as a default. If the state being open is assumed as a default, the CGI meta information to close a predetermined block according to a user instruction is generated, and the information is added to the mobile ML document. Simultaneously, a corresponding server-side script is generated and held on the conversion server side.

The CGI meta information is written in the following format in the mobile ML document. <!- -section=1, summary=“<img src=” . . . gif“> . . . ”- ->

In here, “section” represents a folding instruction directed to the conversion server, and “section=1” represents a section number indicating the serial number of the folding. Subsequent to “summary=”, there is written data which is added to the ML document, when the mobile ML document is automatically generated.

On the other hand, a script which is prepared on the conversion server side in association with the CGI meta information and executed on the conversion server is the PHP script as described above, for instance. The PHP script outputs the mobile ML document which is provided with a link on the aforementioned minus mark 210a or plus mark 210b (e.g., image data), according to whether the state is open or closed.

Hereinafter, a specific explanation will be made as to the editing of the conversion result from the conversion server 150 and modification of the mobile ML document based on a result of the editing, according to the present embodiment.

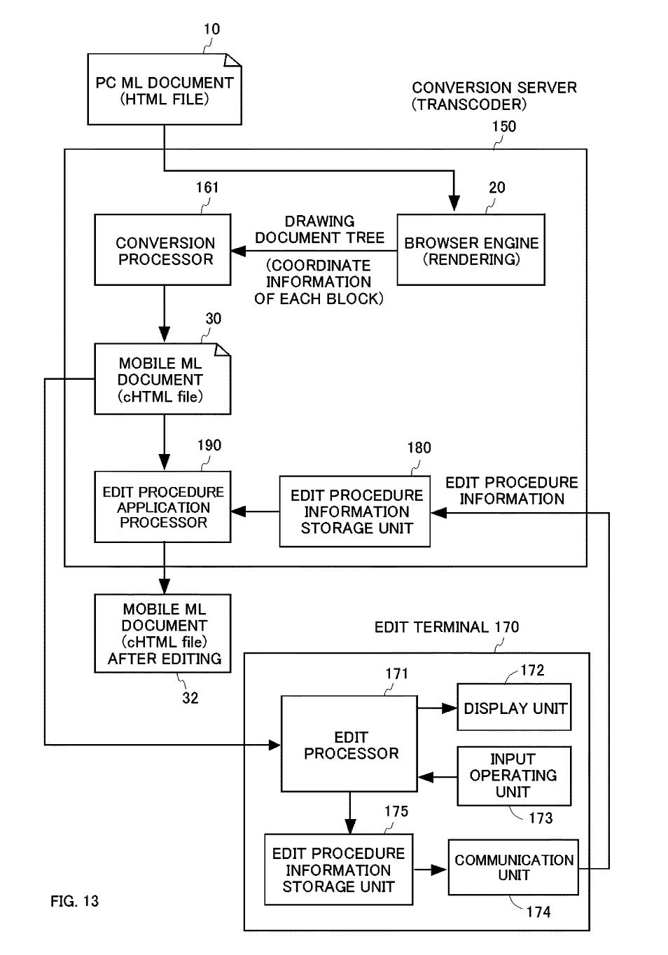

FIG. 13 is a diagram for explaining the edit operation of the conversion result from the conversion server 150, and the modifying operation on the mobile ML document based on a result of the edit operation.

The configurations and functions of the browser engine 20 and the conversion processor 161 in the conversion server 150 are as described above.

On the other hand, a general-use PC as described above may configure the edit terminal 170, and it is provided with an edit processor 171, a display unit 172, an input operating unit 173, and an edit procedure information storage unit 175. The CPU executes a program, thereby implementing the edit processor 171. The display unit 172 is a means for displaying information on the display screen such as an LCD and a CRT. The input operating unit 173 includes a keyboard and a pointing device (for example, a mouse and the like) and receives an input of information and instruction from an editor. The edit procedure information storage unit 175 stores the edit procedure information in which an edit procedure is written, which is a result of the editing by the edit processor 171. The edit procedure information may be written in a scripting language such as the JavaScript, for instance. The communication unit 174 transmits the edit procedure information to the conversion server 150.

In the conversion server 150, the edit procedure information received from the edit terminal 170 is stored in the edit procedure information storage unit 180. The edit procedure application processor 190 applies a corresponding edit procedure to a specific mobile ML document so as to generate a mobile ML document 32 after the edition is performed.

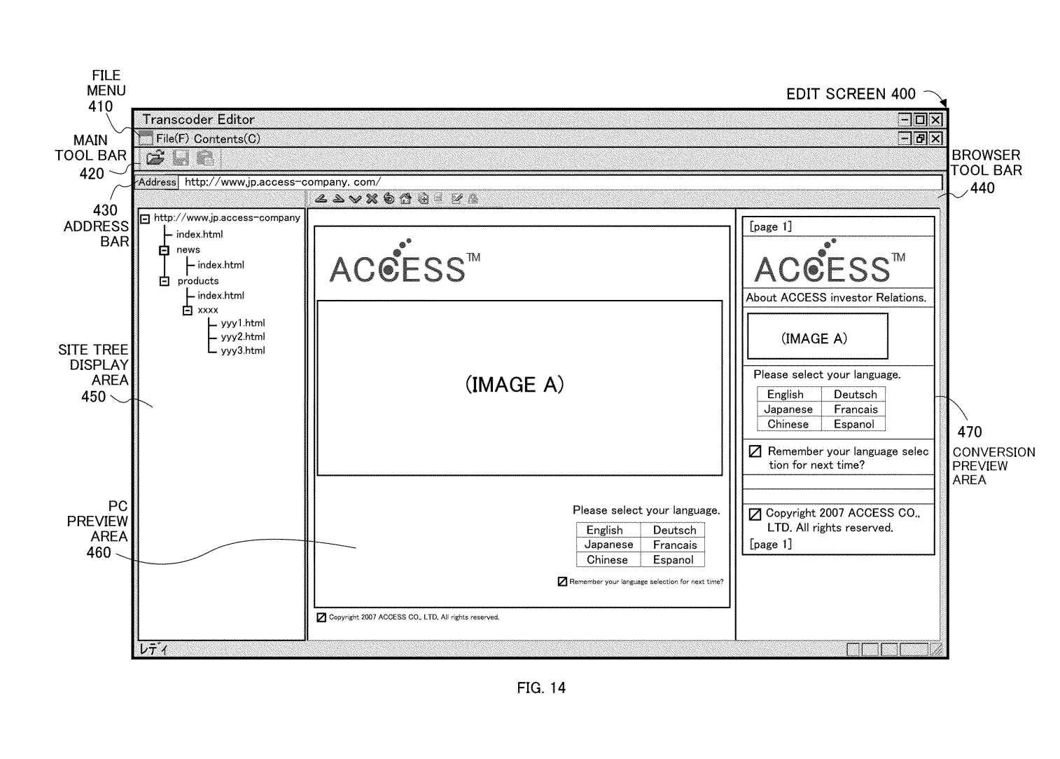

FIG. 14 illustrates a configuration example of an edit screen 400 in the display unit 172 of an edit terminal 170 which is used by the editor. In the edit screen 400, there are arranged from the left side, a site tree display area 450, a PC preview area 470, and a conversion preview area 470, below various band-like areas in the upper part. The various band-like areas in the upper part includes a file menu 410 containing a menu for file operation and contents operation, a main tool bar 420 containing an icon group of main operation tools for editing, an address bar 430 containing an address area designating a URL address, and a browser tool bar 440 containing a group of icons representing various operation commands of the browser.

The main tool bar 420 includes a create button for newly creating edit procedure information, a read button for reading the edit procedure information generated in the past, and a store button for storing the edit procedure information after the editing is performed.

The site tree display area 450 is an area for displaying a group of the PC ML documents any of which may become an editing target. The editor selects any PC ML document from the site tree display area 450, and the details of the document are processed by the browser to obtain a screen therefrom and it is displayed in the PC preview area 470. This corresponds to the screen display on the PC. It is possible to designate a PC ML document as the editing target, by inputting an address directly into the address bar 430.

The conversion preview area 470 is an area for displaying a display screen of the mobile ML document corresponding to the screen of the PC preview area 460. The conversion preview area 470 initially displays the details of the mobile ML document, as a result of automatic conversion by the transcoder engine 160 of the conversion server 150. Using this state as a starting point, the editor starts edit operation. In a conventional edit tool, the mobile ML document is generated from the state where the conversion preview area 470 is a blank. On the other hand, in the present invention, the editing can be started from the result of automatic conversion. Therefore, it is sufficient to edit only the part corresponding to a difference between the starting state and the target state to be reached. The edit operation fixed finally is recorded as the edit operation procedure information as described above, and uploaded to and stored in the conversion server 150.

The display screen of the display unit 172 in the edit terminal 170, including this edit screen 400, supports an interactive operation according to a graphic user interface using a pointing device. Hereinafter, a specific edit example will be explained, taking a screen as an example.

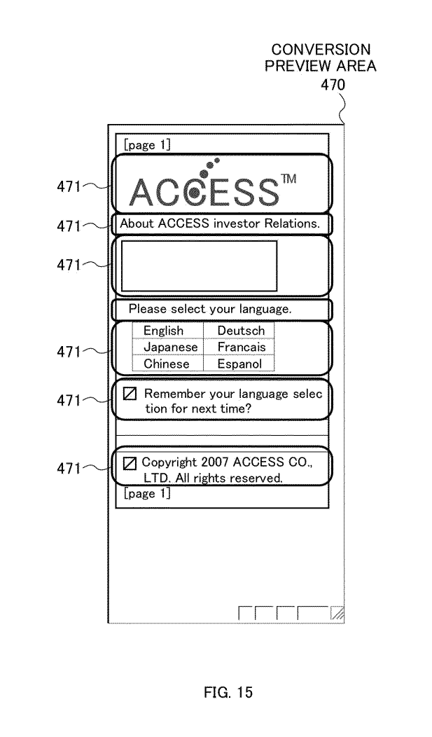

As shown in FIG. 15, the blocks 471 being more than one, exist respectively associated with various display elements within the conversion preview area 470, and each block serves as the unit of editing. In the figure, as a matter of convenience, each block being illustrated is displayed distinctly, but in practice, it is sufficient that only one block being pointed is highlighted to be recognized by a user. Specifically, it is possible to perform operations by the pointing device, such as designation, moving, deletion, addition, and modification of various parts (blocks).

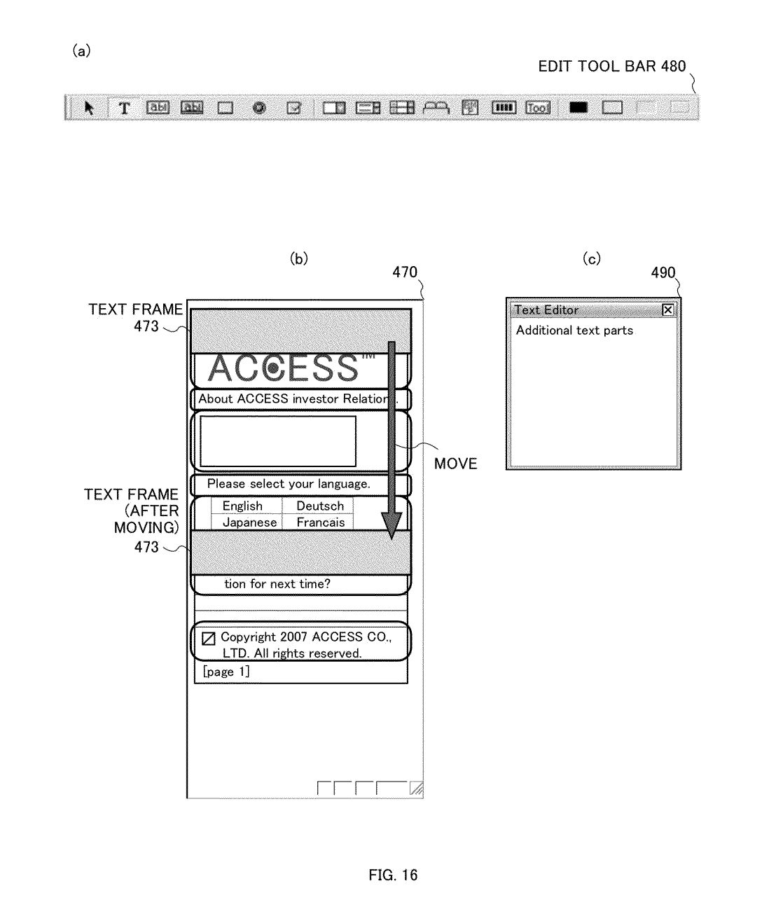

FIG. 16 illustrates an example of “addition of text frame (a type of block)”, as one example of editing. FIG. 16(a) shows an example of the edit tool bar 480 displayed at a predetermined position on the edit screen when the editing is performed. In this particular example, a group of icons respectively associated with various edit operations is arranged within the bar. Designation of a desired icon by the editor triggers the processing of a target edit operation. It is further possible to take another way for the operation; for example, according to a predetermined operation such as right-clicking on the mouse, instead of using the edit bar, a pop-up menu is displayed, and a desired edit operation is selected from the options in the menu.

When the editor designates the icon representing the addition of block, a blank text frame 473 appears in the conversion preview area 470 at a predetermined position (here, the uppermost part) as shown in FIG. 16(b), and the editor is allowed to move this text frame to a desired position downwardly according to an operation using the pointing device. As for the size of the text frame 473, the width thereof is made to fit into the width of the mobile display area, and the height thereof is set to be a default value. In order to decide the position for adding the text frame 473, it is possible to insert the adding block, for instance, at an existing block boundary position which is the closest to the “drop” position of so-called “drag and drop”. In the figure, there are shown two text frames 473, but they simultaneously represent the situations before and after the movement respectively, and in practice, only one frame is displayed at one time. The edit procedure information generated from the edit operation as described above corresponds to the information expressing the procedures on the mobile ML document, such as (1) generating a blank frame, and (2) inserting the generated text frame after block #.

When the position for adding the text frame is determined, the text input screen 490 is displayed as shown in FIG. 16(c), and the editor adds a text (a character string, and the like) to be added in the screen. After the completion of inputting, the text is displayed in the text frame 473. On this occasion, it is possible to configure such that the size of the text frame 473 is automatically increased or decreased, according to the size and volume of the text actually inputted. According to the edit operation as described above, a procedure such as adding the character string inputted in the generated text frame is added to the edit procedure information. The generation and addition of the edit procedure information are similarly applicable to other edit operations described below.

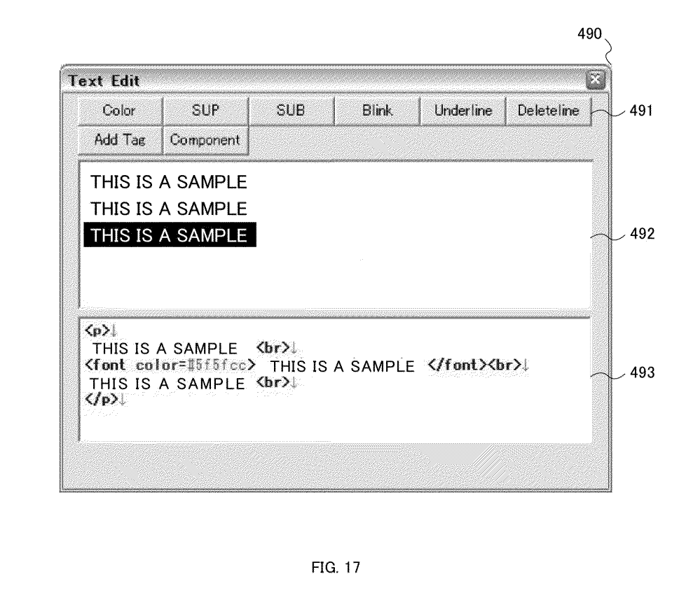

FIG. 17 illustrates a specific configuration example of the text input screen 490. In this particular example, in the contents edit area 492 displaying the text contents in the course of being edited, it is possible to edit the text with decoration, by using any necessary operation command buttons in the group 491. In the source display area 493 provided below the contents edit area 492, there is displayed a source code which corresponds to the current details of the contents edit area 492. It is further possible to directly make a change in the source display area 493. In this case, along with the change, the details of the contents edit area 492 are also updated.

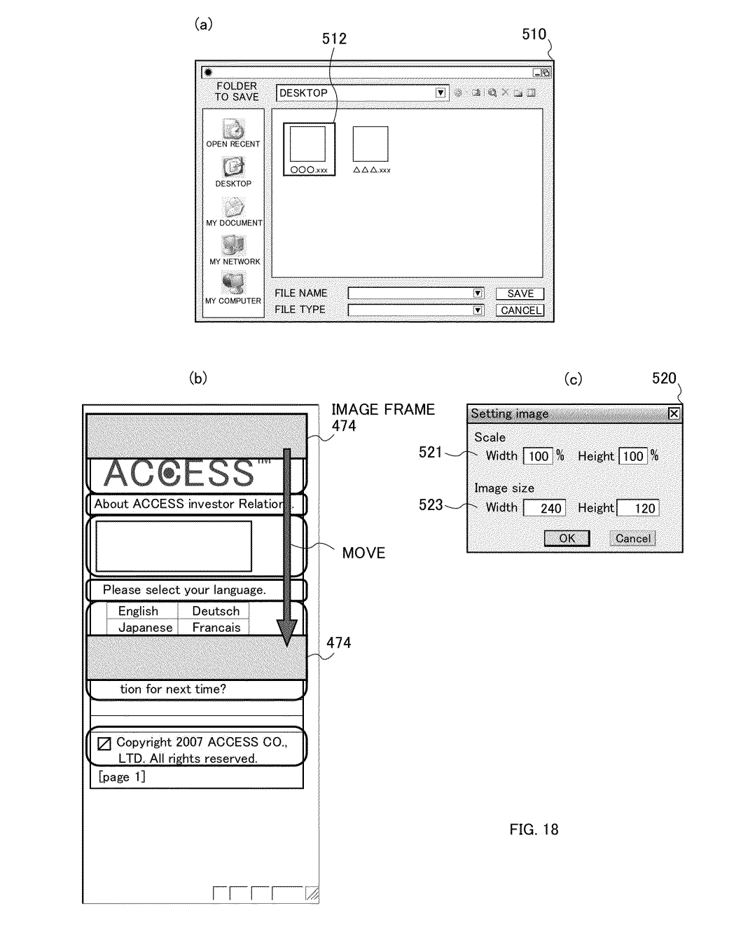

FIG. 18 illustrates an example for adding an image frame, as another example of editing.

When the editor designates an icon for adding an image frame from the edit tool bar 480, which is not illustrated, a blank image frame 474 appears in the conversion preview area 470, similarly to the case of the text frame. Just as in the case of the text frame, the editor is allowed to move the block to a desired position. When the position for inserting the image frame 474 is fixed, the display selection screen 510 as shown in FIG. 18(a) is displayed. An image file 512, which the editor wants to add, is selected from this screen. As shown in FIG. 18(c), a set-up screen 520 is displayed for the image file being selected. This screen includes the field 521 for setting scale ratios in the horizontal direction and in the vertical direction of the image, and the field 523 for setting the image size. The screen allows the user to set the scale ratio and size of the image.

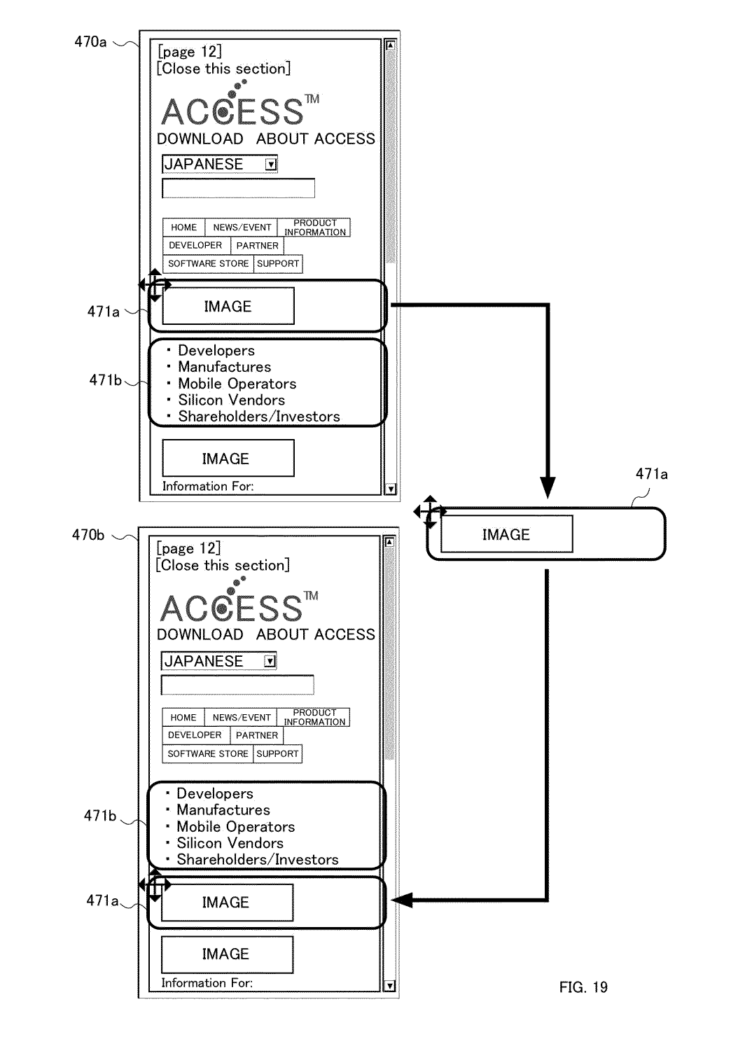

FIG. 19 illustrates the “movement of block” which is to move an existing block as a further alternative example of the editing.

The editor selects a block 471a (here, an image frame) by a pointing device in the conversion preview area before the operation 470a, and according to the drag and drop operation, the block is made to shift to the position below the other block 471b.

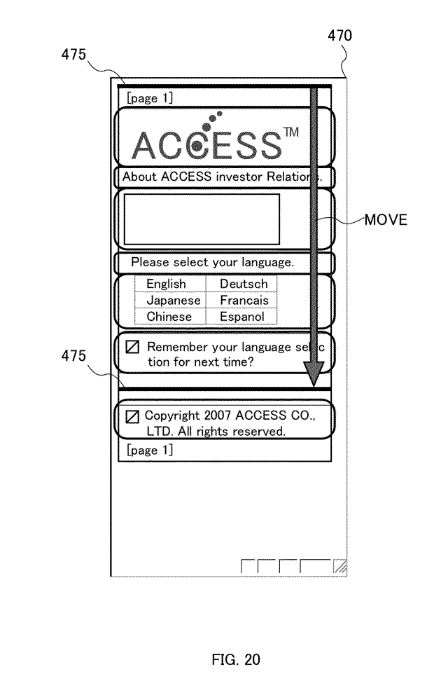

FIG. 20 illustrates the “addition of horizontal line”, as another example of the editing. The horizontal line is a line for partitioning and it is added between any blocks in the mobile web page, in order to improve visualization. The processing details according to this operation are basically the same as the operation for adding a block. In other words, in response to the designation of “addition of horizontal line”, a new horizontal line 475 appears at a predetermined position, and the editor drags and drops this line to a desired block boundary position. Accordingly, as shown in the conversion preview area after the operation 470b, the position of the block being the operation target is modified.

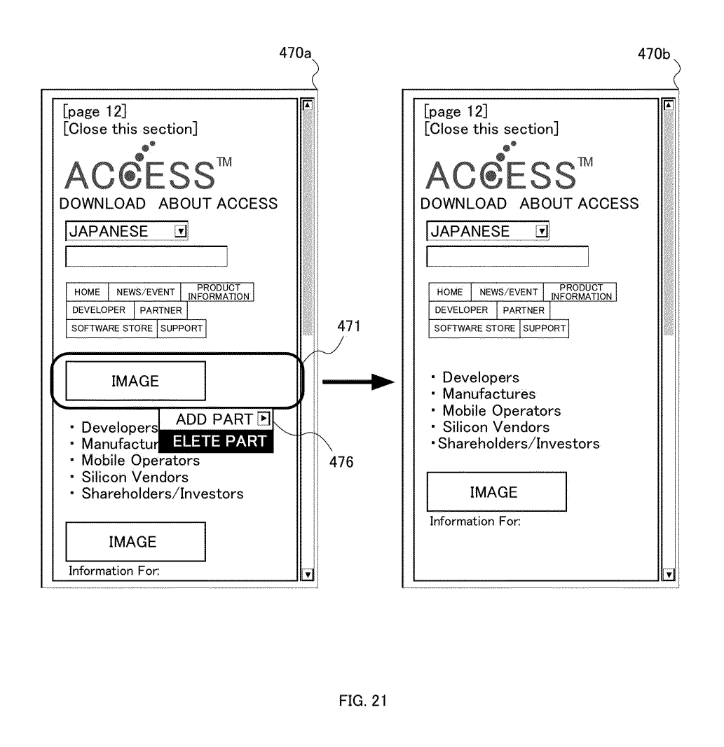

FIG. 21 illustrates the “deletion of block” which deletes an existing block as a further alternative example of the editing.

The editor selects the block 471 (here, an image frame) by a pointing device in the conversion preview area before the operation 470a, makes the pop-up menu 476 to be displayed according to a predetermined operation such as right-click on the mouse, and then, selects the “delete part” as one of the options in the menu. Accordingly, as shown in the conversion preview area after the operation 470b, the part is deleted.

By the way, if an option “add part” is included as shown in the pop-up menu 476, it is possible to add the part as described above. For this case, when the option of “add part” is selected, it is determined which type the part as the addition target belongs to, i.e., a text, an image, or a horizontal line, by displaying a new pop-up menu for selecting a type of the part, urging the editor to select the type. It is alternatively possible that when the option of “add part” is designated in the state where an existing part is already selected, it is determined that the type of the part to be added is the same as that of the part already selected.

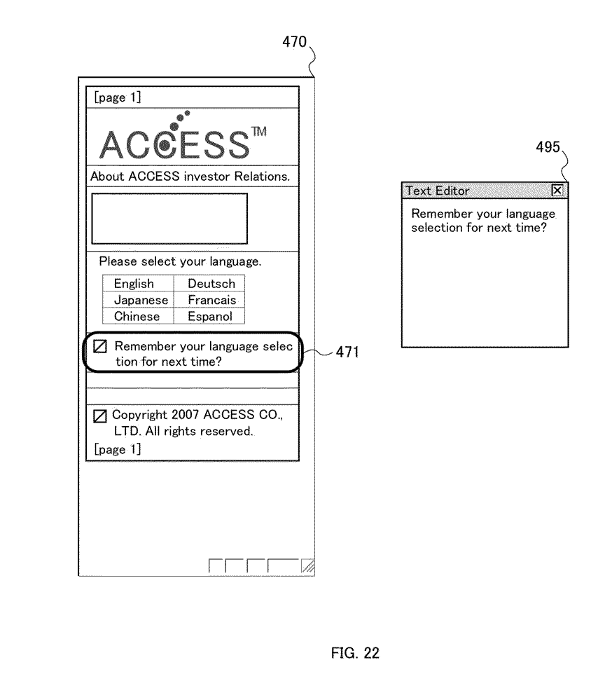

FIG. 22 illustrates the “editing of block” for editing the details of a block, as another example of the editing.

In the conversion preview area 470, the editor selects a block 471 as a target for editing, and instructs the “editing of block” on the selected block, by designating an editing detail from the edit tool bar or the like. This instruction triggers the edit process which is associated with the type of the block. By way of example, as shown in FIG. 22, when editing of the block is performed in the state where the text frame is selected, the text edit screen 495 is displayed similar to the aforementioned example which explains the addition of a text frame. The details of the block before editing are displayed within the text edit screen 495, and the editor manipulates them. When the editing on the text edit screen 495 is finished, the result of the editing is reflected on the block within the conversion preview area 470. When the block being selected is an image frame, a screen for selecting an image is displayed for the replacement. It is alternatively possible to display an image edit screen for modifying the image itself of the image frame being selected, in response to the user's instruction.

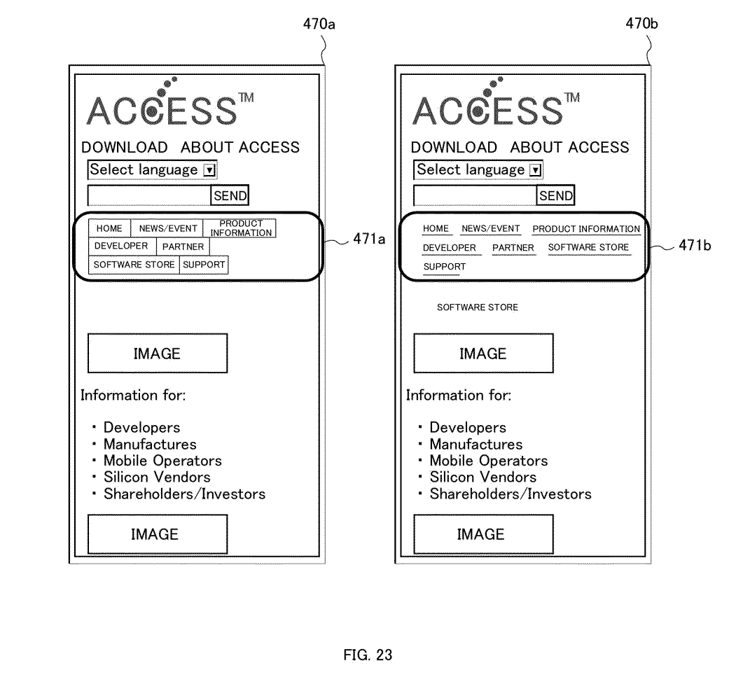

FIG. 23 illustrates an example of the “replacement of image by a text” for replacing an image by a text, as a further alternative example of editing. As for the image, the aforementioned optimization is conducted in the automatic conversion. However, the image has a large data amount relative to a text, and it takes time for downloading on the mobile terminal. According to the “replacement of image by a text”, the editor is allowed to substitute a text for the image so as to reduce the load, and also allowed to edit the image if the image is replaceable by the text without any problem.

In the conversion preview area before the operation 470a, the editor selects a block 471a (here, an image frame) by the pointing device, and changes the image to a name (text) of the “alt” attribute which accompanies an image tag of the image, according to the designation of the “replacement of image by a text” on the edit tool bar or the like. Then, as shown in the conversion preview area after the operation 470b, the part is converted from the image to the text.

Various types of editing are conceivable in addition to the aforementioned example, and the present invention does not exclude such editing operations. By way of example, it is further possible to perform editing to add an advertising frame. Advertising information is added in the adverting frame, by using the opportunity for converting the ML document in the conversion server, and the obtained mobile ML document is transmitted to the user of the mobile terminal.

A menu item “design”, not illustrated, may also be selected, in addition to the individual blocks, the menu item enabling various editing such as setting a background color of the mobile ML document, setting a background image, setting a regular character color, setting a link character color, setting a link character color upon focusing, and inserting a page break.

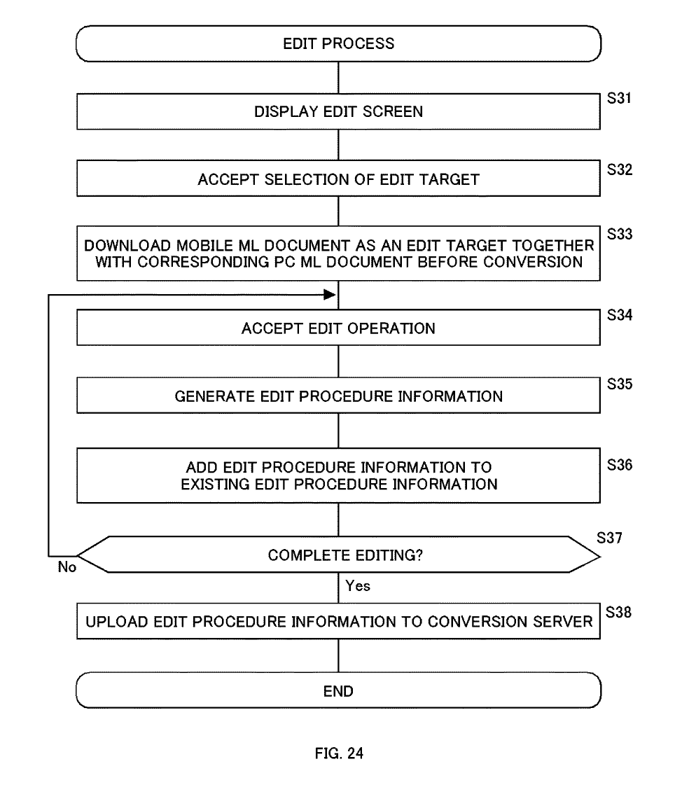

FIG. 24 is a flowchart showing a schematic procedure of the basic edit process on the edit terminal 170. The CPU executes the markup language document edit program, thereby implementing this process.

The edit terminal 170 displays an edit screen in the display unit 172 (FIG. 13) in response to an instruction from the editor (S31). Then, the edit terminal 170 receives from the editor a selection of a target for editing (S32). In response to the received selection, the edit terminal downloads from the conversion server 150, the mobile ML document as the target for editing, together with the PC ML document before conversion which is associated with this mobile ML document (S33). A method for acquiring both of the ML documents is not limited to such downloading. They may be received in the form of a recording medium which stores those documents.

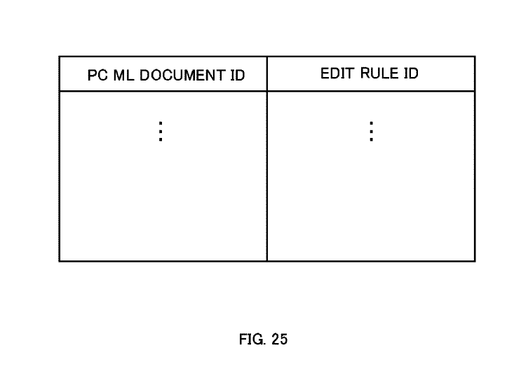

Thereafter, an edit operation is accepted (S34). If there is any edit operation being accepted, the progress of the operation is stored, and every time when one edit operation is completed, edit procedure information is generated (S35). As described above, the edit procedure information is written in JavaScript in the present embodiment. New edit procedure information associated with the same editing target is added to the existing edit procedure information (S36). The processing from the step S34 to the step S36 is repeatedly executed until the editing is completed. When the editing by the editor is completed (S37), the edit procedure information being held is stored in the mobile terminal as a file. In addition, in response to the instruction from the editor, the edit procedure information is uploaded via the communication part 174 to the conversion server 150. The edit procedure information being uploaded is stored in the edit procedure information storage unit 180 within the conversion server 150 as described above. As shown in FIG. 25, the edit procedure information storage unit 180 manages the edit procedure information therein, in such a manner that its edit procedure information ID is associated with the PC ML document ID being the identification information of the corresponding PC ML document. The edit procedure information is illustrated in the form of a data table, but any form is available. The PC ML document ID is sufficient if it is information uniquely identifying the PC ML document. For example, the ID may be a URL of the PC web page, for instance. Similarly, the edit procedure information ID is sufficient if it uniquely identifies the edit procedure information. If a file constitutes the edit procedure information, the ID may be the file name. In addition to or instead of the PC ML document ID, the mobile ML document ID may be used. If the URL serving as the ML document ID designates only a part of a domain name such as “http://www.access.co.jp”, for example, all the URLs having this domain name accompanied by any subsequent path may be targets for applying the edit procedure information being assigned. Alternatively, the URL used as the ML document ID may designate a level which is lower than the domain name. In addition, one edit procedure information ID may be associated with multiple URLs, or multiple edit procedure information IDs may be associated with one URL.

As stated above, preferred embodiments of the present invention have been explained. However, in addition to the description above, various modifications and changes may be possible.

By way of example, the conversion server is assumed as one unit, but multiple units may be provided for balancing load.

The above explanation has been made assuming that the markup language document conversion device of the present invention is a conversion server on a communication network. However, it may be a single unit without any connection with the communication network. Alternatively, it is also possible to apply the functions of the markup language document conversion of the present invention, to other home electric appliance or the like, which is mounted on a home server (home gateway) and connected to a home network.

The script operating on the web browser and the JavaScript used as the edit procedure information may be replaced by other script.

Since there is a possibility that the data amount in the partitioned page is changed after modifying the mobile ML document based on the edit procedure information, another process for updating the page break may be performed.

The mobile ML document once subjected to the edit operation may be further edited. In that case, the edit procedure information already uploaded is downloaded from the conversion server together with the mobile ML document and the like, and the editor updates the edit procedure information according to the editing works. Then, after the re-editing, new edit procedure information is uploaded to the conversion server.

### INDUSTRIAL APPLICABILITY

The present invention is applicable in development, designing, and manufacturing of a mobile communication terminal, a server, and a system including these elements, and further the computer program for those elements.

1. A markup language document conversion system comprising a markup language document conversion device for converting a first markup language document written in a first markup language, into a second markup language document written in a second markup language, and a markup language document edit device for editing the second markup language document being converted, wherein,
the markup language document conversion device comprises:
an acquiring unit for acquiring the first markup language document written in the first markup language, and at least one of a data item and a program which accompanies the first markup language document;
a rendering unit for subjecting the first markup language document and at least one of the data item and the program to rendering, and checking arrangement coordinates of respective display elements to be drawn on a display screen in a predetermined size;
a conversion unit for performing conversion from the first markup language document into the second markup language document written in the second markup language where the respective display elements are rearranged according to the display elements and the arrangement coordinates thereof being checked;
a receiving unit for receiving edit operation procedure information for the second markup language document from the markup language document edit device and storing the information; and
an editing/sending unit for causing the conversion unit to perform the conversion from the first markup language document into the second markup language document in response to an external request, editing the second markup language document according to the edit operation procedure information, and then sending the edited document to a source of the request, and wherein,
the markup language document edit device comprises:
an operating unit for accepting a user operation,
an editing unit for editing on a display screen according to the user operation, the second markup language document that has been converted by the markup language document conversion device; and
a sending unit for sending operation details of the editing to the markup language document conversion device, as the operation procedure information.

2. The markup language document conversion system according to claim 1, further comprising a web server in which the first markup language document is stored, wherein,
the markup language document conversion device acquires the first markup language document from the web server where the first markup language document is stored.

3. The markup language document conversion system according to claim 1,
the first markup language is a PC markup language, whereas the second markup language is a non-PC markup language, and the conversion is performed according to a specification of an individual non-PC terminal.

4. A markup language document conversion device, in a markup language document conversion system comprising the markup language document conversion device for converting a first markup language document written in a first markup language, into a second markup language document written in a second markup language, and a markup language document edit device for editing the second markup language document being converted, wherein,
the markup language document conversion device comprises;
an acquiring unit for acquiring the first markup language document written in the first markup language, and at least one of a data item and a program which accompanies the first markup language document;
a rendering unit for subjecting the first markup language document and at least one of the data item and the program to rendering, and checking arrangement coordinates of respective display elements to be drawn on a display screen in a predetermined size;
a conversion unit for performing conversion into the second markup language document written in the second markup language where the respective display elements are rearranged according to the display elements and the arrangement coordinates thereof being checked;
a receiving unit for receiving edit operation procedure information for the second markup language document from the markup language document edit device and storing the information; and
a conversion unit for performing conversion from the first markup language document into the second markup language document in response to an external request, editing the second markup language document according to the edit operation procedure information, and then sending the edited document to a source of the request.

5. A markup language document edit device in a markup language document conversion system comprising a markup language document conversion device for converting a first markup language document written in a first markup language, into a second markup language document written in a second markup language, and the markup language document edit device for editing the second markup language document being converted, wherein,
the markup language document edit device comprises:
an operating unit for accepting a user operation,
an editing unit for editing on a display screen according to the user operation, the second markup language document that has been converted by the markup language document conversion device; and
a sending unit for sending operation details of the editing to the markup language document conversion device, as the operation procedure information.

6. A markup language document conversion method comprising the steps of:
accepting a request of a first markup language document written in a first markup language,
acquiring the first markup language document written in the first markup language being requested, and at least one of a data item and a program which accompanies the first markup language document;
subjecting the first markup language document and at least one of the data item and the program to rendering;
checking arrangement coordinates of respective display elements to be drawn on a display screen in a predetermined size;
performing conversion into the second markup language document written in the second markup language where the respective display elements are rearranged according to the display elements and the arrangement coordinates thereof being checked;
receiving edit operation procedure information for the second markup language document from an edit device and storing the information; and
performing conversion from the first markup language document into the second markup language document in response to an external request, editing the second markup language document according to the edit operation procedure information, and then sending the edited document to a source of the request.

7. A markup language document editing method comprising the steps of:
accepting an edit operation by a user on a display screen for a second markup language document being converted, the document being obtained from a markup language document conversion device which converts a first markup language document written in a first markup language to a second markup language document written in a second markup language; and
sending details of the edit operation to the markup language document conversion device, as the operation procedure information.

8. A markup language document conversion program which allows a computer to execute the steps of:
accepting a request of a first markup language document written in a first markup language;
acquiring the first markup language document written in the first markup language being requested, and at least one of a data item and a program which accompanies the first markup language document;
subjecting the first markup language document and at least one of the data item and the program to rendering;
checking arrangement coordinates of respective display elements to be drawn on a display screen in a predetermined size;
performing conversion into the second markup language document written in the second markup language where the respective display elements are rearranged according to the display elements and the arrangement coordinates thereof being checked;
receiving edit operation procedure information for the second markup language document from an edit device and storing the information; and
performing conversion from the first markup language document into the second markup language document in response to an external request, editing the second markup language document according to the edit operation procedure information, and then sending the edited document to a source of the request.

9. A markup language document editing program allowing a computer to execute the steps of:
accepting an edit operation by a user on a display screen for a second markup language document being converted, the document being obtained from a markup language document conversion device which converts a first markup language document written in a first markup language to a second markup language document written in a second markup language; and
sending details of the edit operation to the markup language document conversion device, as the operation procedure information.

10. The markup language document conversion system according to claim 2,
the first markup language is a PC markup language, whereas the second markup language is a non-PC markup language, and the conversion is performed according to a specification of an individual non-PC terminal.

11. The markup language document conversion system according to claim 4, further comprising a web server in which the first markup language document is stored, wherein,
the markup language document conversion device acquires the first markup language document from the web server where the first markup language document is stored.

12. The markup language document conversion system according to claim 11,
the first markup language is a PC markup language, whereas the second markup language is a non-PC markup language, and the conversion is performed according to a specification of an individual non-PC terminal.

13. The markup language document conversion system according to claim 12,
the first markup language is a PC markup language, whereas the second markup language is a non-PC markup language, and the conversion is performed according to a specification of an individual non-PC terminal.

14. The markup language document conversion system according to claim 4,
the first markup language is a PC markup language, whereas the second markup language is a non-PC markup language, and the conversion is performed according to a specification of an individual non-PC terminal.

15. The markup language document conversion system according to claim 6, further comprising a web server in which the first markup language document is stored, wherein,
the markup language document conversion device acquires the first markup language document from the web server where the first markup language document is stored.

16. The markup language document conversion system according to claim 6,
the first markup language is a PC markup language, whereas the second markup language is a non-PC markup language, and the conversion is performed according to a specification of an individual non-PC terminal.

17. The markup language document conversion system according to claim 8, further comprising a web server in which the first markup language document is stored, wherein,
the markup language document conversion device acquires the first markup language document from the web server where the first markup language document is stored.

18. The markup language document conversion system according to claim 17,
the first markup language is a PC markup language, whereas the second markup language is a non-PC markup language, and the conversion is performed according to a specification of an individual non-PC terminal.

19. The markup language document conversion system according to claim 8,
the first markup language is a PC markup language, whereas the second markup language is a non-PC markup language, and the conversion is performed according to a specification of an individual non-PC terminal.
